(19) United States
(12) Patent Application Publication
(10) Pub. No.: US 2026/0163667 A1
(43) Pub. Date: Jun. 11, 2026

(54) SECURE COMMUNICATIONS THROUGH FRIEND-AWARE INTELLIGENT JAMMING IN CONTESTED ENVIRONMENTS

(71) Applicant: The Boeing Company, Arlington, VA (US)

(72) Inventors: Jae H. KIM, Bellevue, WA (US); Josh D. ECKHARDT, St. Peters, MO (US); Matthew C. CAESAR, Urbana, IL (US)

(73) Assignees: The Boeing Company, Arlington, VA (US); The Board of Trustees of the University of Illinois, Urbana, IL (US)

(21) Appl. No.: 18/968,391

(22) Filed: Dec. 4, 2024

(51) Int. Cl. H04K 3/00

(52) U.S. Cl. CPC H04K 3/82

(57) ABSTRACT

The present disclosure provides a method of wireless communications in the presence of one or more neighboring signals on a wireless channel. The method includes receiving a first wireless signal by a receiver of an operator, the first wireless signal being influenced by a second wireless signal and a jamming signal that are transmitted on the wireless channel by the operator. The method further includes receiving, at the receiver, a key indicating one or more transmission properties of the jamming signal; generating an estimate of the jamming signal based on the one or more transmission properties; and reconstituting the second wireless signal, which comprises subtracting the estimate from the first wireless signal.

### FIELD

Aspects of the present disclosure relate to wireless communications, and more specifically, to techniques for wireless communications with intelligent jamming in contested environments (e.g., in the presence of one or more neighboring signals on a wireless channel).

### BACKGROUND

Wireless communications are an important enabling technology in a number of different domains. However, wireless communications traverse a wireless channel that is fundamentally difficult to isolate, which makes the wireless communications susceptible to jamming, where the signal is overwhelmed by a jamming signal having a greater amplitude on the same frequency. When this happens, the receiver is unable to decode the transmission as it becomes impossible to distinguish aspects of the signal from the jamming signal. Further, the jammer may operate to cause the received signal to fall outside the reception capabilities of the receiver.

While jamming operations performed by other operators (e.g., by adversary units) are fundamentally disadvantageous to an operator's wireless communications, jamming operations when performed by the same operator or an affiliated operator (e.g., friendly units) can also negatively impact their own wireless communications.

### SUMMARY

The present disclosure provides a method of wireless communications in the presence of one or more neighboring signals on a wireless channel in one aspect, the method including: receiving a first wireless signal by a receiver of an operator, the first wireless signal being influenced by a second wireless signal and a jamming signal that are transmitted on the wireless channel by the operator. The method further includes receiving, at the receiver, a key indicating one or more transmission properties of the jamming signal; generating an estimate of the jamming signal based on the one or more transmission properties; and reconstituting the second wireless signal, which comprises subtracting the estimate from the first wireless signal.

In one aspect, in combination with any example method above or below, the method further includes: detecting interference caused by the neighboring signals on the wireless channel; and filtering the interference to update the estimate of the jamming signal.

In one aspect, in combination with any example method above or below, the method further includes: generating, based on the interference, a feedback signal to control a subsequent estimate of the jamming signal.

In one aspect, in combination with any example method above or below, detecting interference caused by the one or more neighboring signals includes: inferring whether the interference includes a second jamming signal transmitted by another operator.

In one aspect, in combination with any example method above or below, inferring whether the interference includes a second jamming signal includes: receiving a minimum amplitude and a maximum amplitude of a transmitter of the operator; and determining whether an amplitude of the first wireless signal falls outside the minimum amplitude or the maximum amplitude.

In one aspect, in combination with any example method above or below, inferring whether the interference includes a second jamming signal includes determining whether a rate of the second jamming signal is substantially greater or substantially lesser than a rate of the second wireless signal. Filtering the interference includes averaging the first wireless signal.

In one aspect, in combination with any example method above or below, inferring whether the interference includes a second jamming signal includes performing, based on a rate of the second wireless signal, a rate detection algorithm to determine a rate of the second jamming signal.

The present disclosure provides a wireless receiver in one aspect, the wireless receiver including: a memory storing a key indicating one or more transmission properties of a jamming signal; and one or more computer processors configured to: receive a first wireless signal that is influenced by a second wireless signal and the jamming signal that are transmitted on the wireless channel by an operator of the wireless receiver. The one or more computer processors are further configured to: generate an estimate of the jamming signal based on the one or more transmission properties; and reconstitute the second wireless signal, which comprises subtracting the estimate from the first wireless signal.

In one aspect, in combination with any example wireless receiver above or below, the one or more computer processors are further configured to: detect interference caused by one or more neighboring signals on the wireless channel; and filter the interference to update the estimate of the jamming signal.

In one aspect, in combination with any example wireless receiver above or below, the one or more computer processors are further configured to: generate, based on the interference, a feedback signal to control a subsequent estimate of the jamming signal.

In one aspect, in combination with any example wireless receiver above or below, detecting interference caused by the one or more neighboring signals includes:
inferring whether the interference includes a second jamming signal transmitted by another operator.

In one aspect, in combination with any example wireless receiver above or below, inferring whether the interference includes a second jamming signal includes: receiving a minimum amplitude and a maximum amplitude of a transmitter of the operator; and determining whether an amplitude of the first wireless signal falls outside the minimum amplitude or the maximum amplitude.

In one aspect, in combination with any example wireless receiver above or below, inferring whether the interference includes a second jamming signal includes determining whether a rate of the second jamming signal is substantially greater or substantially lesser than a rate of the second wireless signal, and filtering the interference includes averaging the first wireless signal.

In one aspect, in combination with any example wireless receiver above or below, inferring whether the interference includes a second jamming signal includes: performing, based on a rate of the second wireless signal, a rate detection algorithm to determine a rate of the second jamming signal.

The present disclosure provides a wireless communication system in one aspect, the wireless communication system including: one or more wireless transmitters operated by an operator, the one or more wireless transmitters configured to transmit a first wireless signal and a jamming signal on a wireless channel. The wireless communication system further includes a wireless receiver operated by the operator, the wireless receiver configured to: receive a second wireless signal that is influenced by the first wireless signal and the jamming signal; receive a key indicating one or more transmission properties of the jamming signal; generate an estimate of the jamming signal based on the one or more transmission properties; and reconstitute the second wireless signal, which comprises subtracting the estimate from the first wireless signal.

In one aspect, in combination with any example wireless receiver above or below, the one or more wireless transmitters includes a single wireless transmitter configured to: transmit a combined signal comprising a sum of the jamming signal and the first wireless signal.

In one aspect, in combination with any example wireless receiver above or below, the one or more wireless transmitters includes: a first wireless transmitter configured to transmit the first wireless signal; and a second wireless transmitter configured to transmit the jamming signal.

In one aspect, in combination with any example wireless receiver above or below, the wireless receiver further configured to: detect interference caused by one or more neighboring signals on the wireless channel; and filter the interference to update the estimate of the jamming signal.

In one aspect, in combination with any example wireless receiver above or below, the wireless receiver is further configured to: generate, based on the interference, a feedback signal to control a subsequent estimate of the jamming signal.

In one aspect, in combination with any example wireless receiver above or below, detecting interference caused by the one or more neighboring signals includes: inferring whether the interference includes a second jamming signal transmitted by another operator.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 depicts an exemplary wireless communication environment, according to one or more aspects.

FIG. 2 depicts an exemplary wireless communication system, according to one or more aspects.

FIG. 3 depicts an exemplary method of wireless communications in the presence of one or more neighboring signals on a wireless channel, according to one or more aspects.

FIG. 4 depicts an exemplary electronic device, according to one or more aspects.

### DETAILED DESCRIPTION

The present disclosure provides techniques for wireless communications in contested environments (e.g., in the presence of one or more neighboring signals on a wireless channel). As used herein, “neighboring signals” refers to modulated data signals, unmodulated signals, combinations of modulated and unmodulated signals (e.g., based on a level of duty cycle) and/or jamming signals that are transmitted on the same wireless channel as one or more signals of interest. In many cases, the signal(s) of interest are transmitted by an operator, and the neighboring signals are transmitted by other operators and tend to appear as noise when received by receivers of the operator, affecting the ability of the operator to receive and interpret the signal(s) of interest.

In some aspects, a wireless communication system includes one or more wireless transmitters and a wireless receiver that are operated by an operator. The one or more wireless transmitters transmit a first wireless signal and a jamming signal on a wireless channel, and the wireless receiver receives a second wireless signal that is influenced by the first wireless signal and the jamming signal. The wireless receiver further receives a key that indicates one or more transmission properties of the jamming signal (e.g., the key may indicate a pseudorandom sequence for hopping transmission rates). The key is shared by the one or more wireless transmitters. Using the key, the wireless receiver generates an estimate of the jamming signal, and reconstitutes the first wireless signal, which includes subtracting the estimate from the second wireless signal.

In some aspects, the wireless receiver may detect interference caused by the neighboring signals, and filter the interference to update the estimate of the jamming signal. Further, the wireless receiver may infer whether the interference includes a second jamming signal transmitted by another operator (e.g., friendly, neutral, or adversarial), using various techniques discussed in greater detail below.

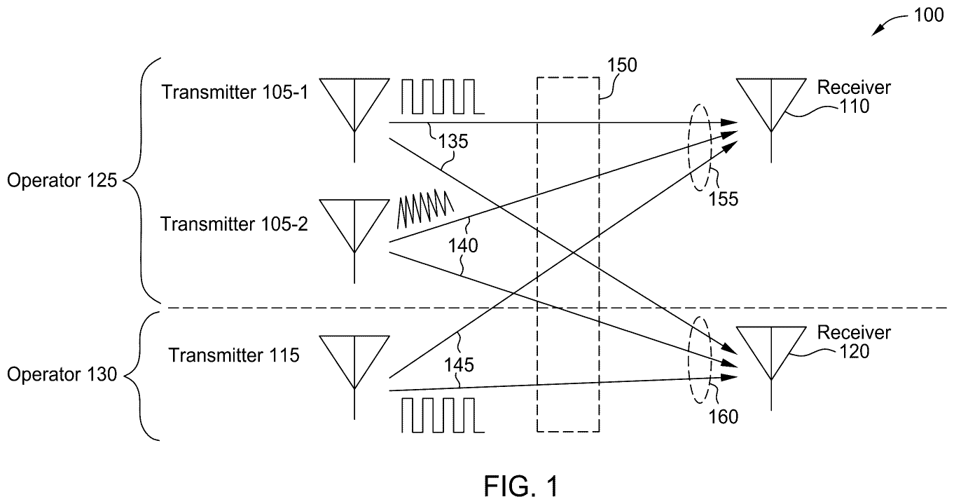

FIG. 1 depicts an exemplary wireless communication environment 100 (“environment 100”), according to one or more aspects. The environment 100 is representative of any environment where wireless communications may be jammed, such as contested tactical environments or civilian applications where an increased prevalence of jamming attacks have been observed. Further, the environment 100 may experience high levels of wireless interference and/or hard-to-correct interference patterns, including industrial facilities, wide-area communications, and complex battlefield environments.

Within the environment 100, a number of devices are operated by a first operator 125 and a number of devices are operated by a second operator 130. As used herein, the first operator 125 may represent one or more affiliated operators that are opposed to (or adversarial to, or in competition with) the second operator 130, which itself may represent one or more operators that may or may not be affiliated with each other.

As shown, the first operator 125 operates one or more wireless transmitters 105-1, 105-2 and a wireless receiver 110. The second operator 130 operates one or more wireless transmitters 115 and a wireless receiver 120. The wireless transmitter 105-1 transmits a first wireless signal 135 on a wireless channel 150, the wireless transmitter 105-2 transmits a jamming signal 140 on the wireless channel 150, and the wireless transmitter 115 transmits a second wireless signal 145 on the wireless channel 150.

Each of the wireless transmitters 105-1, 105-2, 115 and the wireless receivers 110, 120 may be implemented as a respective electronic device. As used herein, an “electronic device” generally refers to any device having electronic circuitry that provides a processing or computing capability, and that implements logic and/or executes program code to perform various operations that collectively define the functionality of the electronic device. The functionality of the electronic device includes a communicative capability with one or more other electronic devices, e.g., when connected to a same network. An electronic device may be implemented with any suitable form factor, whether relatively static in nature (e.g., mainframe, computer terminal, server, kiosk, workstation) or mobile (e.g., laptop computer, tablet, handheld, smart phone, wearable device). The communicative capability between electronic devices may be achieved using any suitable techniques, such as conductive cabling, wireless transmission, optical transmission, and so forth.

The electronic device comprises one or more processors and a memory. The one or more processors are any electronic circuitry, including, but not limited to one or a combination of microprocessors, microcontrollers, application-specific integrated circuits (ASIC), application-specific instruction set processors (ASIP), and/or state machines, that is communicatively coupled to the memory and controls the operation of the system. In some aspects, the electronic circuitry is configured to perform any of the functions described herein. Further, the one or more processors are not limited to a single processing device and may encompass multiple processing devices.

The one or more processors may include other hardware that operates software to control and process information. In some aspects, the one or more processors execute software stored in the memory to perform any of the functions described herein. The one or more processors control the operation and administration of the electronic device by processing information (e.g., information received from input devices and/or communicatively coupled electronic devices).

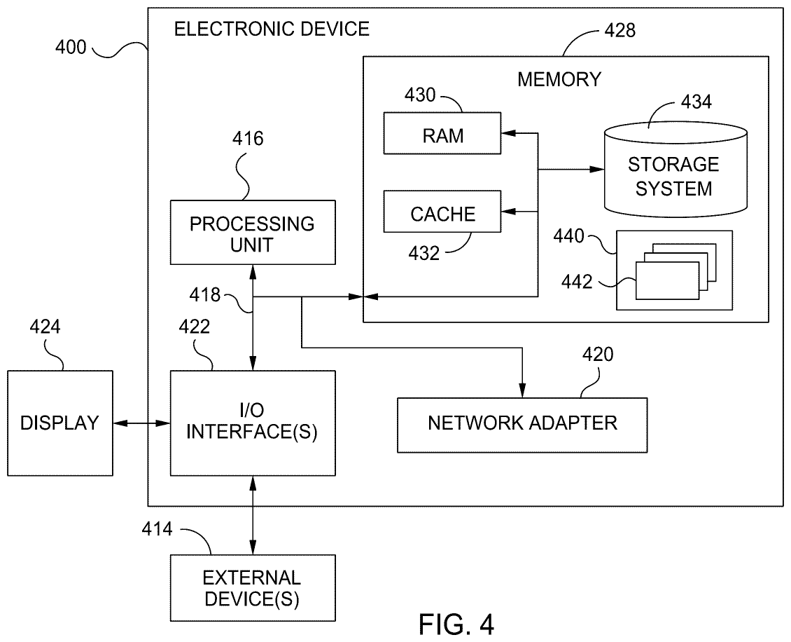

The memory may store, either permanently or temporarily, data, operational software, or other information for the one or more processors. The memory may include any one or a combination of volatile or non-volatile local or remote devices suitable for storing information. For example, the memory may include random-access memory (RAM), read-only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory, a disk, a CD, or a flash drive. In particular embodiments, the software may include an application executable by the one or more processors to perform one or more of the functions described herein. One example implementation of an electronic device is discussed below with respect to FIG. 4.

In some aspects, the second wireless transmitter 105-2 represents a separately implemented jammer, such that the first wireless transmitter 105-1 transmits a first wireless signal 135, and the second wireless transmitter 105-2 transmits a jamming signal 140. However, in other aspects, the first wireless signal 135 and the jamming signal 140 may be combined with the first wireless signal 135 into a single wireless signal that is transmitted by one of the wireless transmitters 105-1, 105-2. As the wireless transmitters 105-1, 105-2 are operated by the first operator 125, the jamming signal 140 in some cases may be generated dependent on the properties of the first wireless signal 135.

The wireless receiver 120 of the second operator 130 receives a third wireless signal 160 that is influenced by the second wireless signal 145, as well as the first wireless signal 135 and the jamming signal 140. Although not shown, the third wireless signal 160 may be further influenced by the properties of the wireless channel 150, other neighboring signals on the wireless channel 150, and in some cases, a separate jamming signal that is transmitted by the second operator 130. In some aspects, the effectiveness of the jamming signal 140 may render the third wireless signal 160 unintelligible by the wireless receiver 120 (e.g., the wireless receiver 120 may be unable to distinguish aspects of the second wireless signal 145 and/or reconstitute the second wireless signal 145).

In transmitting the first wireless signal 135 and the jamming signal 140, the first operator 125 attempts to maintain its use of the portion of the electromagnetic spectrum (corresponding to the wireless channel 150), while degrading or denying use of that portion of the electromagnetic spectrum to the second operator 130. However, the first receiver 110 may also be negatively affected by transmitting the jamming signal 140. More specifically, the wireless receiver 110 of the first operator 125 receives a fourth wireless signal 155 that is influenced by the first wireless signal 135, the jamming signal 140, and the second wireless signal 145. Similar to the third wireless signal 160, the fourth wireless signal 155 may be further influenced by the properties of the wireless channel 150, other neighboring signals on the wireless channel 150, and in some cases, a separate jamming signal that is transmitted by the second operator 130.

Depending on the properties of the first wireless signal 135, the jamming signal 140, the second wireless signal 145, and so forth, the fourth wireless signal 155 may be unintelligible by the wireless receiver 110 (e.g., the wireless receiver 110 may be unable to distinguish aspects of the first wireless signal 135 and/or reconstitute the first wireless signal 135).

According to various aspects, the wireless receiver 110 performs compensation to reduce or remove effects of the jamming signal 140, the second wireless signal 145, the properties of the wireless channel 150, etc. By performing the compensation, the first operator 125 may employ the jamming signal 140 to jam the wireless communications of the second operator 130 without causing the corresponding deleterious effect on the wireless receiver 110, which improves the wireless communications of the first operator 125 within a contested environment 100.

In some aspects, and as will be discussed in greater detail below, a key indicating one or more transmission properties of the jamming signal 140 is shared between the wireless transmitter(s) 105-1, 105-2 and the wireless receiver 110 of the first operator 125. In some aspects, the key enables the wireless receiver 110 to generate an estimate of the jamming signal 140, and to subtract the estimate from the fourth wireless signal 155.

In some aspects, the wireless receiver 110 further detects interference caused by neighboring signals on the wireless channel 150, and filters the interference to update the estimate of the jamming signal 140. Thus, the interference may represent effects from modulated data signals and/or jamming signals on the wireless channel 150, background signals and noises, unintentional interferences, and so forth. In some aspects, the wireless receiver 110 infers whether the interference includes a second jamming signal transmitted by another operator (e.g., the second operator 130), using one or more techniques discussed in greater detail below. The wireless receiver 110 may then generate a second estimate of the second jamming signal, and subtract the second estimate from the fourth wireless signal 155.

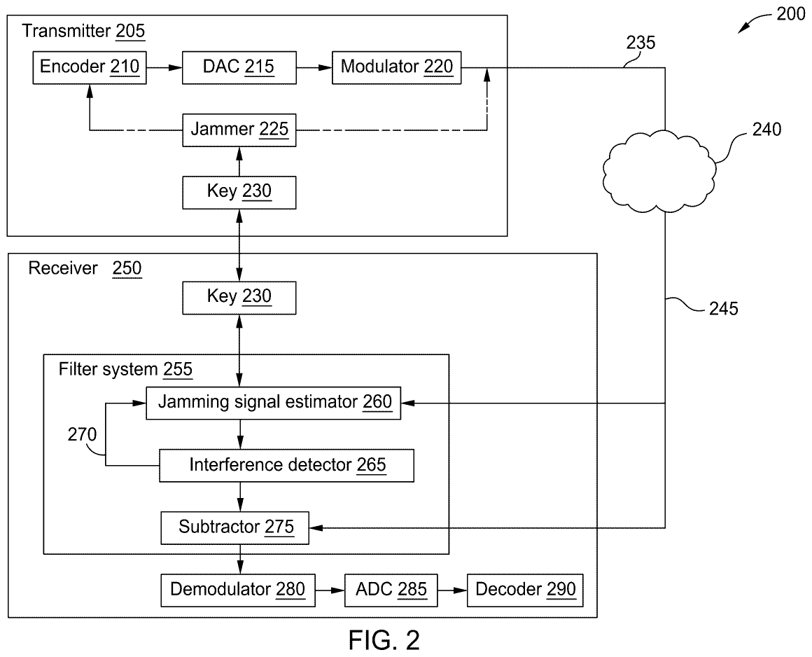

FIG. 2 depicts an exemplary wireless communication system 200 (“system 200”), according to one or more aspects. The features of the system 200 may be used in conjunction with other aspects. For example, the system 200 may be used by the first operator 125 when transmitting the first wireless signal 135 and the jamming signal 140.

The system 200 comprises a transmitter 205 and a receiver 250 that are connected via a wireless network 240. The transmitter 205 comprises an electronic device that incorporates the functionality of the wireless transmitter 105-1 of FIG. 1 (e.g., generating the first wireless signal 135), and in some aspects, also incorporates the functionality of the wireless transmitter 105-2 (e.g., generating the jamming signal 140). In other aspects, another transmitter separate from the transmitter 205 incorporates the functionality of the wireless transmitter 105-2.

The transmitter 205 comprises an encoder 210 that receives data and performs one or more operations to convert the data into a format suitable for further processing and transmission. In some aspects, the encoder 210 encodes the data and/or applies error correction using any suitable techniques. For example, the encoder 210 may apply compression to the data according to a compression standard, and/or may apply Hamming codes or Reed-Solomon codes for error correction purposes.

The encoded data is provided by the encoder 210 to a digital-to-analog converter (DAC) 215 of the transmitter 205. The DAC 215 converts the encoded data into an analog signal, e.g., a continuous analog waveform having the discrete steps of the encoded data converted into corresponding voltage or current levels.

The analog signal is provided by the DAC 215 to a modulator 220 of the transmitter 205. The modulator 220 uses a carrier wave (e.g., a high-frequency sine wave or other periodic waveform) to modulate the analog signal into a frequency suitable for wireless transmission. The modulator 220 may use any suitable analog or digital modulation techniques: amplitude modulation (AM), frequency modulation (FM), phase modulation (PM), quadrature amplitude modulation (QAM), quadrature phase shift keying (QPSK), and so forth. The modulated signal may be amplified by an amplifier of the transmitter 205 (not shown) and wirelessly transmitted by driving one or more antennas of the transmitter 205 (not shown). The transmitter 205 transmits onto the wireless network 240 a first wireless signal 235 that incorporates the modulated signal. In some aspects, the first wireless signal 235 may further incorporate one or more jamming signals, as will be discussed below.

The transmitter 205 further comprises a jammer 225 that generates a jamming signal having one or more transmission properties. Some non-limiting examples of the one or more transmission properties include an amplitude of the jamming signal, a frequency, a phase, a transmission rate, and so forth. In some aspects, the one or more transmission properties include timing information (e.g., a transmit schedule) indicating one or more time periods during which the transmitter 205 (and any other transmitters of the operator in the system 200) may transmit with reduced jamming (e.g., a lesser amplitude, a less-complex jamming technique) or no jamming. In some aspects, the jammer 225 generates a plurality of jamming signals that have different sets of the one or more transmission properties. The jammer 225 may generate the jamming signal(s) according to any suitable techniques, such as broad or narrow noise jamming, spot jamming, sweep jamming, pulse jamming, and so forth, as well as combinations thereof.

In some aspects, the jamming signal is incorporated into the first wireless signal 235 using any suitable techniques. In one example implementation, the jamming signal is provided by the jammer 225 to the encoder 210, and is combined with (e.g., added to) the raw data or the encoded data. In another example implementation, the jamming signal is combined with (e.g., added to) the modulated signal that is provided by the modulator 220.

In some aspects, the one or more transmission properties of each of the jamming signal(s) may be changed over time by the jammer 225. For example, the jammer 225 may perform amplitude hopping or rate hopping according to a predefined sequence (e.g., a pseudorandom sequence), may adapt the one or more transmission properties responsive to detected characteristics of neighboring signals on the wireless channel (e.g., wireless signals transmitted by other operator(s)), and so forth.

In some aspects, the transmitter 205 further comprises a key 230 that indicates the one or more transmission properties of the jamming signal(s). In some aspects, the key 230 indicates a pseudorandom sequence that is used for rate hopping of the jamming signal. For example, the key 230 may include a seed number (or vector) that is used by a pseudorandom number generator of the transmitter 205 to generate the pseudorandom sequence.

In some aspects, the key 230 is shared between the transmitter 205 and the receiver 250, such that the receiver 250 is informed of the one or more transmission properties of the jamming signal(s). The key 230 may be shared using any suitable techniques. It is contemplated that the key 230 may be shared in-band (e.g., at operational radio frequencies) between the transmitter 205 and the receiver 250; however, in some aspects, the key 230 may be distributed out-of-band. For example, the transmitter 205 and the receiver 250 may communicate through a wired or short-range wireless connection and share the key 320 as part of a configuration or handshake operation. In another example, the key 320 may be stored on a removable memory device that the operator of the transmitter 205 and the receiver 250 connects to the receiver 250. In yet another example, the key 320 may be manually entered by the operator using an input device to the receiver 250 (e.g., a keypad, keyboard, etc.).

In some aspects, the receiver 250 is included in a plurality of receivers of the system 200 that receive wireless signals from the transmitter 205. The shared key 320 between the transmitter 205 and the receiver 250 enables the transmitter 205 to selectively determine which of the plurality of receivers can receive the wireless signals. Further, the transmitter 205 is able to perform targeted jamming of certain receivers within the system 200.

The first wireless signal 235 is transmitted through the wireless network 240, and a second wireless signal 245 is received from the wireless network by the receiver 250. The wireless network 240 generally represents the wireless channel 150 of FIG. 1 and may have any suitable properties. Thus, the second wireless signal 245 may be influenced by the first wireless signal 235 (which in some aspects incorporates the jamming signal), the properties of the wireless network 240, and any neighboring signals on the wireless network 240 (e.g., modulated data signals and/or jamming signals transmitted by other operator(s)).

The receiver 250 comprises an electronic device that incorporates the functionality of the wireless receiver 110. One or more antennas of the receiver 250 (not shown) receive the second wireless signal 245, which may be amplified by an amplifier of the receiver 250 (not shown).

In some aspects, the receiver 250 uses the key 230 to dynamically adjust its reception timing to read the bits included in the wireless signal 245. The receiver 250 comprises a filter system 255 that filters jamming signal(s) that are transmitted by the same operator, and/or neighboring signals that are transmitted by other operator(s).

A jamming signal estimator 260 of the filter system 255 receives the second wireless signal 245, and using the key 230, generates (or synthesizes) an estimate of the jamming signal that is included within the second wireless signal 245. The estimate of the jamming signal is based on the one or more transmission properties indicated by the key 230. In some aspects, the estimate of the jamming signal has at least some of the one or more transmission properties (e.g., frequency, phase, transmission rate).

The jamming signal estimator 260 may have any suitable implementation, such as a statistical model or a machine learning model implemented in software and/or hardware. In some aspects, the jamming signal estimator 260 determines an average of the jamming signal by channel estimation techniques, e.g., observing the channel if the transmitter 205 is known to not transmit at some interval, or by observing long-term amplitude properties of the jamming signal. Further, the shared key 320 (or information derived from the key) may also be used to refine the estimate of the jamming signal.

In some aspects, an interference detector 265 of the filter system 255 receives the second wireless signal 245 and/or the estimate of the jamming signal, and detects interference caused by the neighboring signals on the wireless channel. The interference detector 265 filters the interference to update the estimate of the jamming signal. The interference detector 265 may have any suitable implementation, such as a statistical model or a machine learning model implemented in software and/or hardware.

In some aspects, the interference detector 265 generates, based on the interference, a feedback signal 270 to control a subsequent estimate of the jamming signal. For example, the interference detector 265 may provide information about the properties of neighboring signals that enables the jamming signal estimator 260 to better isolate the jamming signal within the second wireless signal 245. Various properties of the neighboring signals are contemplated, such as a spectral density, distribution, frequency range, a type of the interference (e.g., bursty or periodic), environmental or other known factors, and so forth. Further, in some aspects, the operator may provide input as to these properties based on knowledge.

In some aspects, the interference detector 265 infers whether the interference includes a second jamming signal transmitted by another operator. The additive effects of the first wireless signal 235 (including the jamming signal) and neighboring signals in the wireless channel, in combination with improved estimates of the jamming signal from the second wireless signal 245 at the receiver 250, allow the

In some aspects, the interference detector 265 uses information about the transmitter 205 to infer whether the interference includes the second jamming signal. In some aspects, the interference detector 265 receives a minimum amplitude and a maximum amplitude of the transmitter 205, e.g., during a handshake operation with the transmitter 205. The minimum amplitude and the maximum amplitude effectively define an expected range of the amplitude of the second wireless signal 245. The interference detector 265 determines whether an amplitude of the second wireless signal 245 falls outside the minimum amplitude or the maximum amplitude, and if so, the interference detector 265 infers that the interference includes the second jamming signal. Other values defining the expected range of the amplitude are also contemplated (e.g., the minimum amplitude of the transmitter 205+10%, the maximum amplitude of the transmitter 205−10%).

In one example implementation, the interference detector 265 receives the second wireless signal 245 and a transmit schedule of the transmitter 205. The interference detector 265 defines a window as the length of the current bit of the second wireless signal 245 received by the receiver 250. The length of the current bit may be determined from the transmit schedule. For example, assuming that the second wireless signal 245 includes a transmitted “1” value from a time index 4 to a time index 8, the window is defined as 4 to 8, inclusive.

The interference detector 265 determines whether the window includes a “0” value or a “2” value. In some cases, a “0” value results only from a “0” in the modulated signal and a “0” in the jamming signal, and a “2” value results only from a “1” in the modulated signal and a “1” in the jamming signal. Thus, if a “0” value is detected in the window, the interference detector 265 infers that the value of the modulated signal within the window is a “0” during the entire window. If a “2” value is detected in the window, the interference detector 265 infers that the value of the modulated signal within the window is a “1” during the entire window. In the case that the window includes a “1” value, the value of the modulated signal may be inconclusive. Various techniques may be used to estimate the value of the modulated signal. In some aspects, a random estimate of the value may be used.

In some aspects, the interference detector 265 detects a transmission rate within the interference, and infers whether the interference includes the second jamming signal based on a comparison of the detected transmission rate with a transmission rate of the second wireless signal 245.

In some aspects, the interference detector 265 infers whether the interference includes a second jamming signal comprises determining whether a rate of the second jamming signal is substantially greater or substantially lesser than a rate of the second wireless signal. In some aspects, a rate of the second jamming signal is considered substantially greater than a transmission rate of the second wireless signal 245 when a ratio of the rates, respectively, is 5:1 or greater. In some aspects, a rate of the second jamming signal is considered substantially lesser than a transmission rate of the second wireless signal 245 when a ratio of the rates is 1:5 or lesser. Other ratios or relative measures are also contemplated, so long as the difference in rates are detectable.

In one example implementation, in the case where the rate of the second jamming signal is substantially greater (e.g., a 5:1 ratio or greater), the jamming signal will appear as high-frequency noise that is overlaid on the modulated signal. The interference detector 265 receives the second wireless signal 245, the transmit schedule of the transmitter 205, and optionally a value of the window size. In other aspects, a default value of the window size may be applied. The interference detector 265 averages the second wireless signal 245, and more specifically, the number of previous bits of the second wireless signal 245 corresponding to the value of the window size. If the average is greater than 1, the interference detector 265 infers that the value of the modulated signal within the window is a “1” value. If the average is less than or equal to 1, the interference detector 265 infers that the value of the modulated signal within the window is a “0” value.

In another example implementation, in the case where the rate of the second jamming signal is substantially lesser (e.g., a 1:5 ratio or lesser), the jamming signal will appear as high-frequency noise that is overlaid on the modulated signal. The interference detector 265 receives the second wireless signal 245, the transmit schedule of the transmitter 205, and optionally a value of the window size. In other aspects, a default value of the window size may be applied. The interference detector 265 averages the second wireless signal 245, and more specifically, the number of previous bits of the second wireless signal 245 corresponding to the value of the window size. The average is subtracted from the values of the second wireless signal 245, which effectively filters the second jamming signal from the second wireless signal 245 and, in some cases, recovers the modulated signal.

In some aspects, the interference detector 265 infers a transmission rate of the second jamming signal by performing a rate detection algorithm based on the known transmission rate of the transmitter 205. In one non-limiting example, the rate detection algorithm comprises a discrete spectral line extraction algorithm that includes reflecting the amplitude advantage of discrete spectral lines through salient features of continuous noises in discrete spectral line neighborhood. Based on the determined (inferred) transmission rate, the interference detector 265 may perform filtering techniques to filter the second jamming signal from the second wireless signal 245 and, in some cases, recovers the modulated signal.

Based on the estimate of the jamming signal, provided by the jamming signal estimator 260 and in some cases updated by the interference detector 265, a subtractor 275 of the filter system subtracts the estimate of the jamming signal from the received second wireless signal 245. In some aspects, the subtractor 275 may be implemented as an inverter and a summer.

The result of the subtraction is provided to a demodulator 280, an analog-to-digital converter (ADC) 285, and a decoder 290 of the receiver 250. The demodulator 280 generally removes the carrier wave embedded in the second wireless signal 245 using any suitable demodulation techniques corresponding to the modulation provided by the modulator 220 (e.g., AM, FM, PM, QAM, QPSK, and so forth), and returns a baseband signal. The ADC 285 generally converts the baseband signal into a digital signal, typically through sampling, quantization, and digitization. The decoder 290 generally decompresses the digital signal and/or performs error detection and correction. Thus, the receiver 250 is able to reconstitute the original data provided to the transmitter 205.

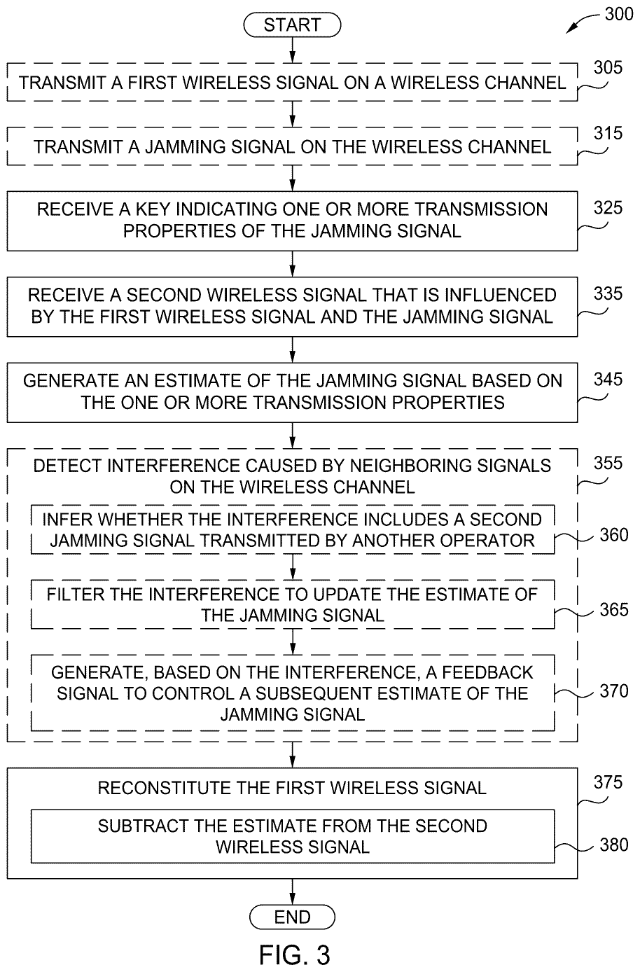

FIG. 3 depicts an exemplary method 300 of wireless communications in the presence of one or more neighboring signals on a wireless channel, according to one or more aspects. The method 300 may be performed in conjunction with other aspects, such as by components of the system 200 (the transmitter 205 and/or the receiver 250) of FIG. 2.

The method 300 begins at an optional block 305, where the transmitter 205 transmits a first wireless signal on a wireless channel. The transmitter 205 is operated by a first operator. At an optional block 315, a jamming signal is transmitted on the wireless channel by the first operator. In some aspects, the jamming signal is incorporated into the first wireless signal (e.g., transmitted by the same transmitter 205). In other aspects, the jamming signal is transmitted separate from the first wireless signal (e.g., by a transmitter other than the transmitter 205).

At block 325, the receiver 250 receives a key 230 indicating one or more transmission properties of the jamming signal. In some aspects, the key 230 is shared between the transmitter 205 and the receiver 250 out-of-band, such as through a wired or short-range wireless connection. In other aspects, the key 230 is manually entered into the receiver 250 using an input device. Some non-limiting examples of the one or more transmission properties include amplitude, frequency, phase, transmission rate, transmit schedule, and so forth.

At block 335, the receiver 250 receives a second wireless signal that is influenced by the first wireless signal and the jamming signal. In some aspects, the second wireless is further influenced by the properties of the wireless channel and/or one or more neighboring signals on the wireless channel, which may include jamming signal(s) transmitted by other operator(s).

At block 345, the receiver 250 (e.g., the jamming signal estimator 260) generates an estimate of the jamming signal based on the one or more transmission properties. In some aspects, generating the estimate of the jamming signal comprises determining an average of the jamming signal, e.g., by channel estimation techniques.

At an optional block 355, the receiver 250 (e.g., the interference detector 265) detects interference caused by neighboring signals on the wireless channel. In some aspects, detecting interference caused by the neighboring signals on the wireless channel comprises, at block 360, inferring whether the interference includes a second jamming signal transmitted by another operator. In some aspects, detecting interference caused by the neighboring signals on the wireless channel comprises, at block 365, filtering the interference to update the estimate of the jamming signal. In some aspects, detecting interference caused by the neighboring signals on the wireless channel comprises, at block 370, generating, based on the interference, a feedback signal to control a subsequent estimate of the jamming signal.

At block 375, the receiver 250 reconstitutes the first wireless signal. In some aspects, reconstituting the first wireless signal comprises, at block 380, subtracting the estimate from the second wireless signal. The method 300 ends following completion of block 375.

FIG. 4 depicts an exemplary electronic device 400, according to one or more aspects. The features of FIG. 4 may be used in conjunction with other aspects, e.g., representing one example implementation of the transmitter 205 and/or the receiver 250 of FIG. 2.

As shown, the electronic device 400 has the form of a general-purpose computing device, but may alternately be implemented as a special-purpose computing device. The components of electronic device 400 may include, but are not limited to, one or more processors or processing units 416, a system memory 428, and a bus 418 that couples various system components including system memory 428 to the processor 416.

The bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The electronic device 400 may include a variety of computer system readable media. Such media may be any available media that is accessible by the electronic device 400, and it includes both volatile and non-volatile media, removable and non-removable media.

The system memory 428 can include non-transitory computer system readable media in the form of volatile memory, such as random access memory (RAM) 430 and/or cache memory 432. The electronic device 400 may further include other removable/non-removable, volatile/non-volatile computer system storage media. By way of example only, the storage system 434 can be provided for reading from and writing to a non-removable, non-volatile magnetic media (not shown and typically called a hard disk drive (HDD) or solid state disk drive (SSD)). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to the bus 418 by one or more data media interfaces. As will be further depicted and described below, the memory 428 may include at least one program product having a set (e.g., at least one) of program modules that are configured to carry out the functions of embodiments of the invention.

A program/utility 440, having a set (at least one) of program modules 442, may be stored in the memory 428 by way of example, and not limitation, as well as an operating system, one or more application programs, other program modules, and program data. Each of the operating system, one or more application programs, other program modules, and program data or some combination thereof, may include an implementation of a networking environment. The program modules 442 generally carry out the functions and/or methodologies of embodiments of the invention as described herein.

The electronic device 400 may also communicate with one or more external devices 414 such as a keyboard, a pointing device, a display 424, etc. ; one or more devices that enable a user to interact with the electronic device 400; and/or any devices (e.g., network card, modem, etc.) that enable the electronic device 400 to communicate with one or more other computing devices. Such communication can occur via input/output (I/O) interfaces 422. Still yet, the electronic device 400 can communicate with one or more networks such as a local area network (LAN), a general wide area network (WAN), and/or a public network (e.g., the Internet) via a network adapter 420. As depicted, the network adapter 420 communicates with the other components of the electronic device 400 via the bus 418. It should be understood that although not shown, other hardware and/or software components could be used in conjunction with the electronic device 400. Examples include, but are not limited to: microcode, device drivers, redundant processing units, external disk drive arrays, RAID systems, tape drives, and data archival storage systems, etc.

Thus, the various aspects described herein provide a wireless communications architecture that is resilient to jamming signals as well as interference from neighboring signals, allowing wireless systems to operate in environments despite high wireless interference. Further, the wireless systems permit operators of friendly units to communicate while contemporaneously driving jamming signals to jam the communications of operators of adversary units.

In the current disclosure, reference is made to various aspects. However, it should be understood that the present disclosure is not limited to specific described aspects. Instead, any combination of the preceding features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method of wireless communications in the presence of one or more neighboring signals on a wireless channel, the method comprising:
receiving a first wireless signal by a receiver of an operator, the first wireless signal being influenced by a second wireless signal and a jamming signal that are transmitted on the wireless channel by the operator;
receiving, at the receiver, a key indicating one or more transmission properties of the jamming signal;
generating an estimate of the jamming signal based on the one or more transmission properties; and
reconstituting the second wireless signal, which comprises subtracting the estimate from the first wireless signal.

2. The method of claim 1, further comprising:
detecting interference caused by the neighboring signals on the wireless channel; and
filtering the interference to update the estimate of the jamming signal.

3. The method of claim 2, further comprising:
generating, based on the interference, a feedback signal to control a subsequent estimate of the jamming signal.

4. The method of claim 2, wherein detecting interference caused by the one or more neighboring signals comprises:
inferring whether the interference includes a second jamming signal transmitted by another operator.

5. The method of claim 4, wherein inferring whether the interference includes a second jamming signal comprises:
receiving a minimum amplitude and a maximum amplitude of a transmitter of the operator; and
determining whether an amplitude of the first wireless signal falls outside the minimum amplitude or the maximum amplitude.

6. The method of claim 4,
wherein inferring whether the interference includes a second jamming signal comprises determining whether a rate of the second jamming signal is substantially greater or substantially lesser than a rate of the second wireless signal, and
wherein filtering the interference comprises averaging the first wireless signal.

7. The method of claim 4, wherein inferring whether the interference includes a second jamming signal comprises:
performing, based on a rate of the second wireless signal, a rate detection algorithm to determine a rate of the second jamming signal.

8. A wireless receiver comprising:
a memory storing a key indicating one or more transmission properties of a jamming signal; and
one or more computer processors configured to:
receive a first wireless signal that is influenced by a second wireless signal and the jamming signal that are transmitted on the wireless channel by an operator of the wireless receiver;
generate an estimate of the jamming signal based on the one or more transmission properties; and
reconstitute the second wireless signal, which comprises subtracting the estimate from the first wireless signal.

9. The wireless receiver of claim 8, the one or more computer processors further configured to:
detect interference caused by one or more neighboring signals on the wireless channel; and
filter the interference to update the estimate of the jamming signal.

10. The wireless receiver of claim 9, the one or more computer processors further configured to:
generate, based on the interference, a feedback signal to control a subsequent estimate of the jamming signal.

11. The wireless receiver of claim 9, wherein detecting interference caused by the one or more neighboring signals comprises:
inferring whether the interference includes a second jamming signal transmitted by another operator.

12. The wireless receiver of claim 11, wherein inferring whether the interference includes a second jamming signal comprises:
receiving a minimum amplitude and a maximum amplitude of a transmitter of the operator; and
determining whether an amplitude of the first wireless signal falls outside the minimum amplitude or the maximum amplitude.

13. The wireless receiver of claim 11,
wherein inferring whether the interference includes a second jamming signal comprises determining whether a rate of the second jamming signal is substantially greater or substantially lesser than a rate of the second wireless signal, and
wherein filtering the interference comprises averaging the first wireless signal.

14. The wireless receiver of claim 11, wherein inferring whether the interference includes a second jamming signal comprises:
performing, based on a rate of the second wireless signal, a rate detection algorithm to determine a rate of the second jamming signal.

15. A wireless communication system comprising:
one or more wireless transmitters operated by an operator, the one or more wireless transmitters configured to transmit a first wireless signal and a jamming signal on a wireless channel; and
a wireless receiver operated by the operator, the wireless receiver configured to:
receive a second wireless signal that is influenced by the first wireless signal and the jamming signal;
receive a key indicating one or more transmission properties of the jamming signal;
generate an estimate of the jamming signal based on the one or more transmission properties; and
reconstitute the second wireless signal, which comprises subtracting the estimate from the first wireless signal.

16. The wireless communication system of claim 15, wherein the one or more wireless transmitters comprises:
a single wireless transmitter configured to:
transmit a combined signal comprising a sum of the jamming signal and the first wireless signal.

17. The wireless communication system of claim 15, wherein the one or more wireless transmitters comprises:
a first wireless transmitter configured to transmit the first wireless signal; and
a second wireless transmitter configured to transmit the jamming signal.

18. The wireless communication system of claim 15, the wireless receiver further configured to:
detect interference caused by one or more neighboring signals on the wireless channel; and
filter the interference to update the estimate of the jamming signal.

19. The wireless communication system of claim 18, the wireless receiver further configured to:
generate, based on the interference, a feedback signal to control a subsequent estimate of the jamming signal.

20. The wireless communication system of claim 18, wherein detecting interference caused by the one or more neighboring signals comprises:
inferring whether the interference includes a second jamming signal transmitted by another operator.
